(19) United States
(12) Patent Application Publication
(10) Pub. No.: US 2026/0143195 A1
(43) Pub. Date: May 21, 2026

(54) CONTENT OUTPUT SYSTEM AND CONTENT OUTPUT CONTROL METHOD

(71) Applicant: HONDA MOTOR CO., LTD., Tokyo (JP)

(72) Inventor: Takashi Noguchi, Tokyo (JP)

(21) Appl. No.: 19/355,045

(22) Filed: Oct. 10, 2025

(30) Foreign Application Priority Data
Nov. 15, 2024 (JP) 2024-199409

(51) Int. Cl. H04N 21/462; H04N 21/414; H04N 21/4223; H04N 21/442

(52) U.S. Cl. CPC H04N 21/4622; H04N 21/41422; H04N 21/4223; H04N 21/44209

(57) ABSTRACT

A content output system including: a plurality of content output devices mounted on a vehicle; and a control unit that controls the content output devices, wherein the control unit includes: a first content acquisition unit that acquires content by receiving broadcast waves; a second content acquisition unit that acquires content by receiving data from an Internet; and an output control unit that causes the content output devices to output content, and the output control unit determines content to be output by the content output devices to be content that is acquired by the first content acquisition unit or content that is acquired by the second content acquisition unit, based on a reception situation of the broadcast waves and a communication situation of the Internet.

### INCORPORATION BY REFERENCE

The present application claims priority under 35 U.S.C. § 119 to Japanese Patent Application No. 2024-199409 filed on Nov. 15, 2024. The content of the application is incorporated herein by reference in its entirety.

### BACKGROUND OF THE INVENTION

### Field of the Invention

The present invention relates to a content output system and a content output control method.

### Description of the Related Art

Conventionally, techniques for controlling a plurality of content output devices mounted on a vehicle have been known. For example, Japanese Patent No. 5298811 discloses displays, each of which is disposed at a location corresponding to a seat in a vehicle, as a plurality of content output devices mounted on the vehicle. Japanese Patent No. 5298811 also discloses an in-vehicle device that outputs an application function from a mobile terminal device brought into the vehicle using a display corresponding to the mobile terminal device.

Some content output devices mounted on vehicles are capable of outputting two types of content: content obtained from broadcast waves and content obtained from the Internet. In this type of content output device, an occupant can perform special operations such as switching content depending on the reception situation of the broadcast waves and the communication situation of the Internet. Therefore, when a vehicle has a plurality of content output devices of this type, special operations may be performed on the plurality of content output devices and may be troublesome for the occupant. For this reason, there is room for improvement in the convenience of the occupant relating to content output.

Therefore, an object of the present invention is to improve convenience of an occupant relating to content output in a vehicle equipped with a plurality of content output devices.

### SUMMARY OF THE INVENTION

An aspect of the present invention is a content output system including: a plurality of content output devices mounted on a vehicle; and a control unit that controls the content output devices, wherein the control unit includes: a first content acquisition unit that acquires content by receiving broadcast waves; a second content acquisition unit that acquires content by receiving data from an Internet; and an output control unit that causes the content output devices to output content, and the output control unit determines content to be output by the content output devices to be first content or second content based on a reception situation of the broadcast waves and a communication situation of the Internet, the first content being acquired by the first content acquisition unit, the second content being acquired by the second content acquisition unit.

According to an aspect of the present invention, convenience of an occupant relating to content output can be improved in a vehicle equipped with a plurality of content output devices.

### BRIEF DESCRIPTION OF THE DRAWINGS

FIG. 1 is a diagram showing a configuration of a vehicle;

FIG. 2 is a block diagram showing a configuration of a content output system;

FIG. 3 is a flowchart showing operation of a control ECU;

FIG. 4 is a flowchart showing operation of the control ECU in first processing;

FIG. 5 is a flowchart showing operation of the control ECU in second processing;

FIG. 6 is a flowchart showing operation of the control ECU in third processing; and

FIG. 7 is a flowchart showing operation of the control ECU in fourth processing.

### DETAILED DESCRIPTION OF THE PREFERRED EMBODIMENTS

### 1. Configuration of Vehicle

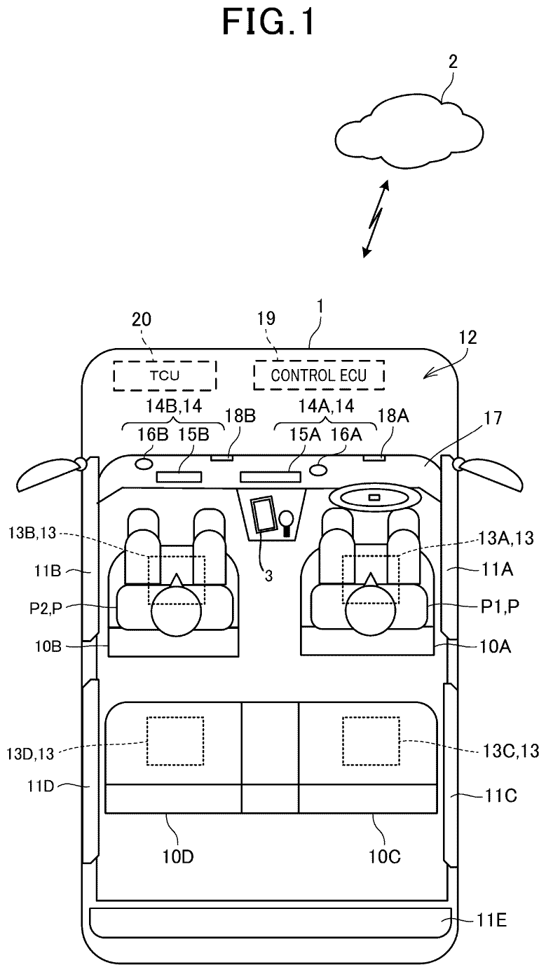

FIG. 1 is a diagram showing a configuration of a vehicle 1.

The vehicle 1 illustrated in FIG. 1 is a four-wheeled vehicle. The vehicle 1 has a driver's seat 10A, a passenger seat 10B, a rear right seat 10C, and a rear left seat 10D. In the vehicle 1 of FIG. 1, a driver P1 and a passenger P2 are riding as occupants P of the vehicle 1. In the vehicle 1 of FIG. 1, a situation is shown in which the driver P1 is sitting in the driver's seat 10A. Furthermore, in the vehicle 1 of FIG. 1, a situation is shown in which passenger P2 is sitting in the passenger seat 10B.

The vehicle 1 is equipped with a right front door 11A, a left front door 11B, a right rear door 11C, a left rear door 11D, and a tailgate 11E. Opening the right front door 11A, the left front door 11B, the right rear door 11C, and the left rear door 11D makes it possible to enter and exit from the passenger compartment of the vehicle 1. The tailgate 11E opens and closes the trunk of the vehicle 1.

The vehicle 1 includes a content output system 12. The content output system 12 is a system that outputs content into the passenger compartment.

The content output system 12 is equipped with seat sensors 13A, 13B, 13C, 13D that detect the weight applied to the seats. The seat sensor 13A is provided in the driver's seat 10A, the seat sensor 13B is provided in the passenger seat 10B, the seat sensor 13C is provided in the rear right seat 10C, and the seat sensor 13D is provided in the rear left seat 10D.

In the following description, if the seat sensors 13A, 13B, 13C, 13D are not distinguished from one another, they will be referred to as “seat sensors 13” with the reference numeral “13”.

The content output system 12 includes content output devices 14A, 14B that output content. The content output device 14A includes a display 15A and a speaker 16A. The content output device 14B includes a display 15B and a speaker 16B.

In the following description, if the content output devices 14A, 14B are not distinguished from one another, they will be referred to as “content output devices 14” with the reference numeral “14”.

Displays 15A, 15B are each composed of a display panel that displays characters and images and a touch sensor that detects contact with the display panel, which are superimposed or integrated. The displays 15A and 15B are installed on a dashboard 17. The display 15B is installed closer to the passenger seat 10B than the display 15A. The type of content to be output can be selected by the occupant P's touch operation on each of the displays 15A and 15B.

The speaker 16A outputs sound to the driver P1 sitting in the driver's seat 10A. The speaker 16B outputs sound to the passenger P2 sitting in the passenger seat 10B. The installation positions of the speakers 16A, 16B are not limited to those shown in FIG. 1, and may be any positions that allow sound to be output to the occupants P sitting in the corresponding seats.

The content output system 12 is equipped with cameras 18A, 18B that image the inside of the passenger compartment. The imaging range of the camera 18A is set to a range in which the driver P1 sitting in the driver's seat 10A can be imaged. More specifically, the imaging range of the camera 18A is set to a range in which the head of the driver P1 sitting in the driver's seat 10A can be imaged. The imaging range of the camera 18B is set to a range in which the passenger P2 sitting in the passenger seat 10B can be imaged. More specifically, the imaging range of the camera 18B is set to a range in which the head of the passenger P2 sitting in the passenger seat 10B can be imaged. The cameras 18A, 18B may be replaced with a single camera as long as the camera can image the driver P1 and the passenger P2.

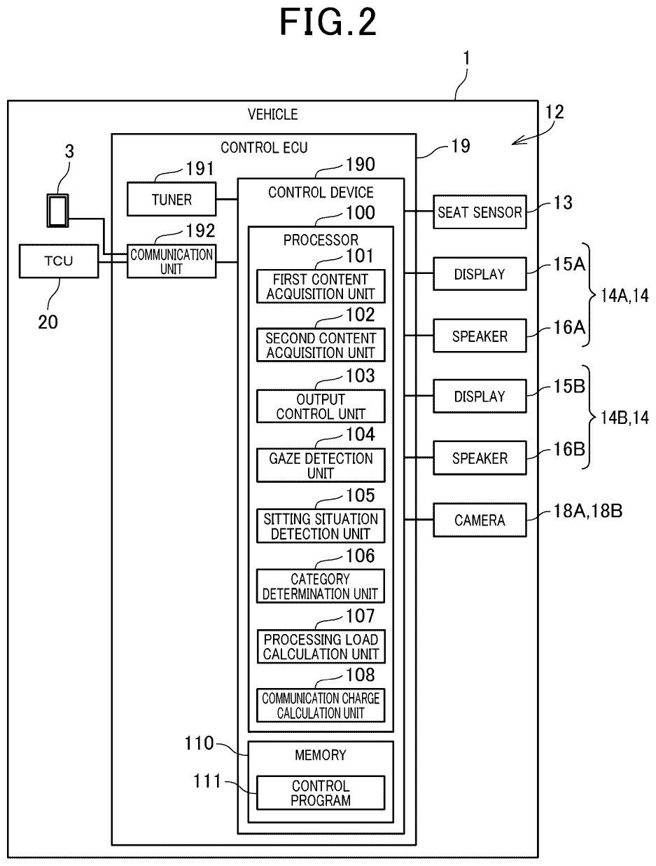

The content output system 12 includes a control ECU (Electronic Control Unit) 19. The control ECU 19 is a control device that controls the content output devices 14. The control ECU 19 includes one tuner 191 (see FIG. 2) and receives broadcast waves such as radio broadcast and television broadcast. Furthermore, the control ECU 19 receives data from the Internet 2 via the TCU (Telematics Control Unit) 20. The control ECU 19 receives data from the Internet 2 via the mobile terminal 3 brought into the vehicle 1.

The control ECU 19 corresponds to a “control unit”.

Vehicle 1 is equipped with TCU 20. The TCU 20 connects to the Internet 2.

### 2. Configuration of Content Output System

FIG. 2 is a block diagram showing a configuration of the content output system 12.

The control ECU 19 includes a control device 190, a tuner 191, and a communication unit 192.

Before describing the control device 190, the tuner 191 and the communication unit 192 will be described.

The tuner 191 operates under the control of the control device 190. The tuner 191 receives broadcast waves via an antenna (not shown). The tuner 191 converts the received broadcast waves into signals indicating content-related information. The tuner 191 outputs the converted signals to the control device 190. The content-related information is information related to the content, and includes content information indicating the content that the content output device 14 can output and category information indicating the category of the content. The content information includes video data and audio data if the content is composed of video and audio, includes video data if the content is composed of video, and includes audio data if the content is composed of audio.

The tuner 191 outputs a signal indicating the reception intensity of the broadcast waves to the control device 190.

The communication unit 192 includes communication hardware such as a communication circuit and a connector. The communication unit 192 receives data from the Internet 2 via the TCU 20 or the mobile terminal 3 under the control of the control device 190. The communication unit 192 outputs the received data to the control device 190. The communication unit 192 of this embodiment receives data including content-related information.

The control device 190 includes a processor 100 such as a CPU (Central Processing Unit) or an MPU (Micro Processor Unit), a memory 110, and an interface circuit for connecting other devices and sensors. The control device 190 is connected to the tuner 191, the communication unit 192, the seat sensors 13, the content output devices 14, and the cameras 18A, 18B.

The memory 110 is a storage device that stores a program and data. The memory 110 stores a control program 111, data to be processed by the processor 100, and the like. The memory 110 has a non-volatile storage area. The memory 110 may include a volatile storage area and may form a work area for the processor 100. The memory 110 includes, for example, a ROM (Read Only Memory) or a RAM (Random Access Memory).

The control program 111 is a program that causes the processor 100 to function as functional units described below.

The processor 100 executes the control program 111, to function as a first content acquisition unit 101, a second content acquisition unit 102, an output control unit 103, a gaze detection unit 104, a sitting situation detection unit 105, a category determination unit 106, a processing load calculation unit 107, and a communication charge calculation unit 108.

### [2-1. First Content Acquisition Unit]

The first content acquisition unit 101 controls the tuner 191 to receive broadcast waves, and thereby acquires content. More specifically, the first content acquisition unit 101 controls the tuner 191 to acquire content-related information from the tuner 191.

The content acquired by the first content acquisition unit 101 will be referred to as a “first content” below.

### [2-2. Second Content Acquisition Unit]

The second content acquisition unit 102 controls the communication unit 192 to receive data from the Internet 2, and thereby acquires content. More specifically, the second content acquisition unit 102 controls the communication unit 192 to acquire content-related information from the communication unit 192.

The content acquired by the second content acquisition unit 102 will be referred to as a “second content” below.

### [2-3. Output Control Unit]

The output control unit 103 causes the content output devices 14 to output the first content or the second content. The output control unit 103 causes the content output devices 14 to output the first content based on the content information of the content-related information acquired by the first content acquisition unit 101. The output control unit 103 causes the content output devices 14 to output the second content based on the content information of the content-related information acquired by the second content acquisition unit 102.

The output control unit 103 determines whether the content to be output by the content output devices 14 is the first content or the second content depending on the reception situation of the broadcast waves and the communication situation of the Internet 2. In this determination, the output control unit 103 acquires the reception intensity of the broadcast waves from the tuner 191. In this determination, the output control unit 103 also acquires the communication speed of the Internet 2. The output control unit 103 transmits acquisition data for acquiring the communication speed to the Internet 2 via the communication unit 192, and receives a response for the acquisition data from the Internet 2. The output control unit 103 acquires the communication speed of the Internet 2 by dividing the data amount of the response for the acquisition data by the time required to receive the response for the acquisition data.

### [2-4. Gaze Detection Unit]

The gaze detection unit 104 detects the gaze direction of the occupants P. In this embodiment, when the driver P1 is sitting in the driver's seat 10A, the gaze detection unit 104 detects the gaze direction of the driver P1. In addition, in this embodiment, when passenger P2 is sitting in the passenger seat 10B, the gaze detection unit 104 detects the gaze direction of the passenger P2.

The gaze detection unit 104 detects the driver P1 from the image captured by the camera 18A. Gaze detection unit 104 detects a facial image using a technique such as pattern matching to detect driver P1 from the image captured by camera 18A. When the gaze detection unit 104 can detect the driver P1 from the image captured by the camera 18A, it detects the eyes from the captured image using pattern matching, color, etc., and detects the direction in which the detected eyes are facing as the gaze direction of the driver P1. Data required for eye detection (eye shape data and color data) is stored in the memory 110.

The gaze detection unit 104 detects the passenger P2 from the image captured by the camera 18B. Gaze detection unit 104 detects a facial image using a technique such as pattern matching to detect passenger P2 from the image captured by the camera 18B. When the gaze detection unit 104 can detect the passenger P2 from the image captured by the camera 18B, it detects the eyes from the captured image using pattern matching, color, etc., and detects the direction in which the detected eyes are facing as the gaze direction of the passenger P2.

### [2-5. Sitting Situation Detection Unit]

The sitting situation detection unit 105 detects the sitting situation of the occupants P in the vehicle 1 based on the detection result of the seat sensors 13. For example, it is assumed that the seat sensor 13 that detects a weight equal to or greater than the predetermined value is only the seat sensor 13A. The predetermined value is a value that distinguishes whether a person is sitting in the seat or not. In the case of this example, the sitting situation detection unit 105 detects that the occupant P is sitting only in the driver's seat 10A as the sitting situation. In addition, for example, it is assumed that the seat sensors 13 that detect a weight equal to or greater than a predetermined value are only the seat sensors 13A and 13B. In the case of this example, the sitting situation detection unit 105 detects that the occupants P are sitting in the driver's seat 10A and the passenger seat 10B as the sitting situation.

### [2-6. Category Determination Unit]

The category determination unit 106 determines the category of the first content. The category determination unit 106 determines the category of the first content based on category information of the content-related information acquired by the first content acquisition unit 101. For example, when the category information indicates “traffic”, the category determination unit 106 determines that the category of the first content is “traffic”. Note that content of the category “traffic” is content such as congestion situation, road closures, and accidents. For example, when the category information indicates “news”, the category determination unit 106 determines that the category of the first content is “news”.

The category determination unit 106 determines the category of the second content. The category determination unit 106 determines the category of the second content based on category information of the content-related information acquired by the second content acquisition unit 102. For example, when the category information indicates “entertainment”, the category determination unit 106 determines that the category of the second content is “entertainment”.

### [2-7. Processing Load Calculation Unit]

The processing load calculation unit 107 calculates the processing load related to content output. The processing load related to content output includes the processing load required for receiving the content and the processing load required for content output. The processing load calculation unit 107 calculates the processing load related to the output of the first content and the processing load related to the output of the second content using existing technique.

### [2-8. Communication Charge Calculation Unit]

The communication charge calculation unit 108 calculates the communication charge related to the reception of the second content. The communication charge calculation unit 108 calculates the communication charge related to the reception of the second content based on the amount of data received by the communication unit 192. For example, if “β yen” is added for each received data amount α GB (gigabyte), the communication charge calculation unit 108 calculates the communication charge related to the reception of the second content based on the amount of data received by the communication unit 192 and the addition of “β yen” for each α GB.

### 3. Operation of Control ECU

Next, the operation of the control ECU 19 will be described.

In this embodiment, the vehicle 1 includes one tuner 191. Therefore, in this embodiment, the content output devices 14A, 14B cannot output the first content simultaneously. This is because the tuner 191 cannot receive broadcast waves of different frequencies simultaneously. On the other hand, in this embodiment, the content output devices 14A, 14B can simultaneously output the second content. Note that when one of the content output devices 14A, 14B is outputting the first content, the other content output device 14 is set so that the first content cannot be output by operation of the occupant P.

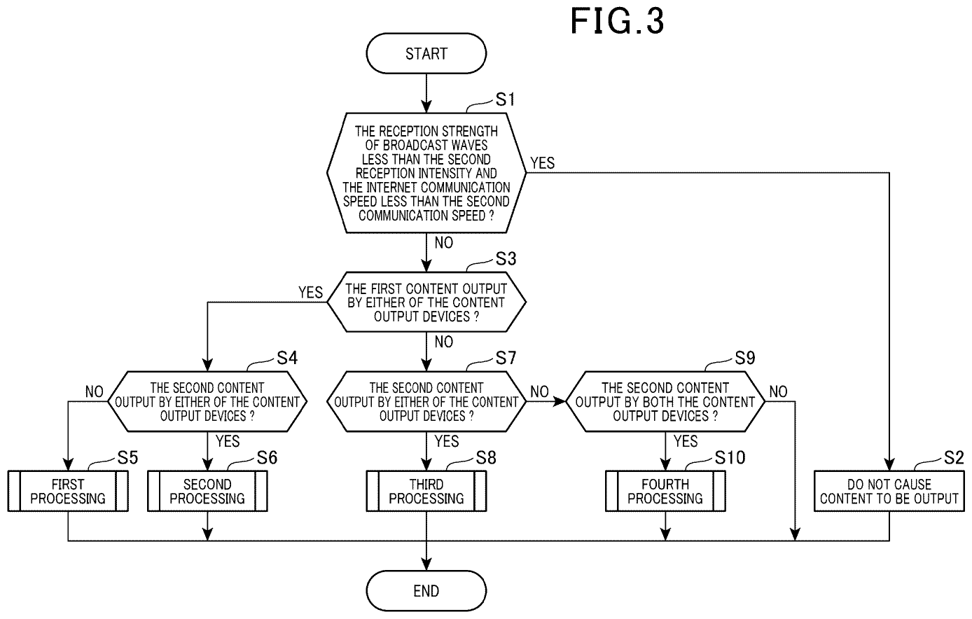

FIG. 3 is a flowchart showing the operation of the control ECU 19.

The output control unit 103 determines whether the reception intensity of the broadcast waves is less than a second reception intensity that is less than a first reception intensity and the communication speed of the Internet 2 is less than a second communication speed that is less than a first communication speed (step S1).

Here, the first reception intensity, the second reception intensity, the first communication speed, and the second communication speed will be described.

The first reception intensity is an intensity at which it is recommended to switch the content to be output to the second content. The second reception intensity is an intensity at which it is recommended, from the viewpoint of viewability and audibility, not to output the first content. The first reception intensity and the second reception intensity are determined by prior testing, simulation, and the like.

The first communication intensity is an intensity at which it is recommended to switch the content to be output to the first content. The second communication intensity is an intensity at which it is recommended, from the viewpoint of viewability and audibility, not to output the second content. The first communication intensity and the second communication intensity are determined by prior testing, simulation, and the like.

If the output control unit 103 determines that the reception intensity of the broadcast waves is less than the second reception intensity and that the communication speed of the Internet 2 is less than the second communication speed (step S1: YES), it does not cause the content output devices 14 to output content (step S2).

If the content output device 14 has already output the content in step S2, the output control unit 103 stops the content output made by the content output device 14.

If the content output device 14 is not outputting content in step S2, the output control unit 103 makes it impossible to output content by operating the displays 15A, 15B, for example, by disabling a software button that starts content output.

Returning to the description of step S1, if step S1 makes a negative determination (step S1: NO), the output control unit 103 determines whether either the content output devices 14A or the device 14B is outputting the first content (step S3).

If the output control unit 103 determines that either content output device 14A or the device 14B is outputting the first content (step S3: YES), it determines whether either content output device 14A or the device 14B is outputting the second content (step S4).

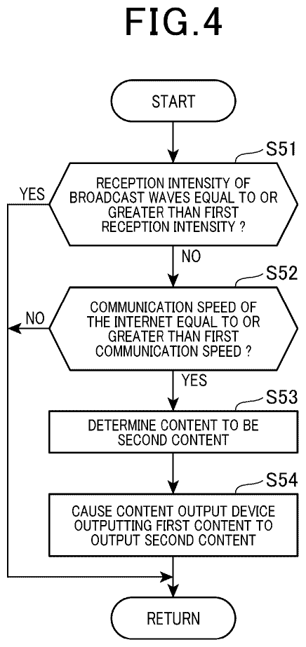

If the output control unit 103 determines that either the content output device 14A or the device 14B is not outputting the second content (step S4: NO), it executes a first processing (step S5). The first processing will be described later with reference to FIG. 4.

A negative determination made in step S4 means that either the content output device 14A or the device 14B is outputting the first content, but neither the content output device 14A nor the device 14B is outputting the second content.

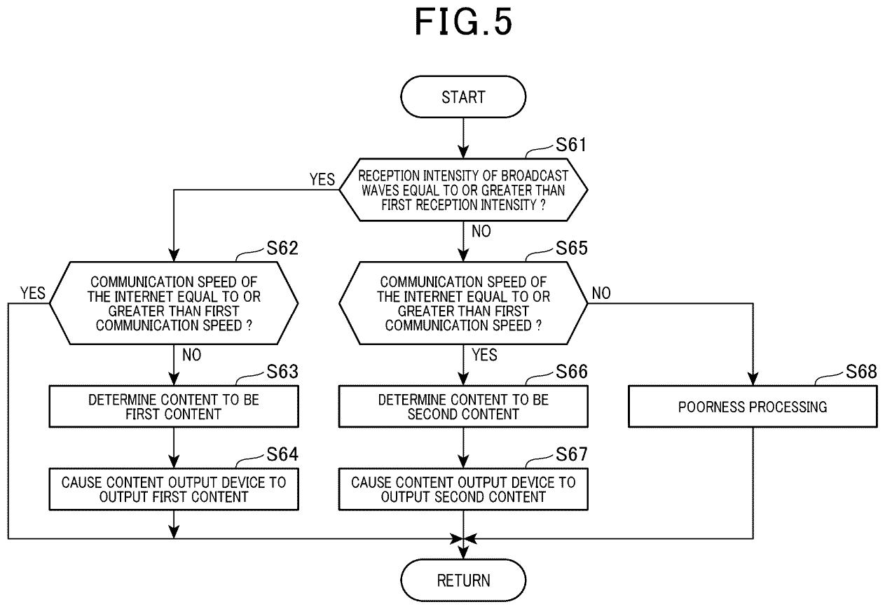

Returning to the description of step S4, if the output control unit 103 determines that either the content output device 14A or the device 14B is outputting the second content (step S4: YES), it executes the second processing (step S6). The second processing will be described later with reference to FIG. 5.

A positive determination made in step S4 means that either the content output device 14A or the device 14B is outputting the first content, and the content output device 14 different from the content output device 14 outputting the first content is outputting the second content.

Returning to the description of step S3, if the output control unit 103 determines that either the content output device 14A or the device 14B is not outputting the first content (step S3: NO), it determines whether either the content output device 14A or the device 14B is outputting the second content (step S7).

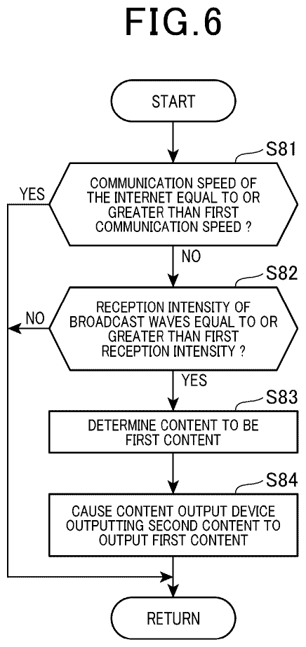

If the output control unit 103 determines that either the content output device 14A or the device 14B is outputting the second content (step S7: YES), it executes a third processing (step S8). The third processing will be described later with reference to FIG. 6.

A positive determination made in step S7 means that either the content output device 14A or the device 14B is outputting the second content, but neither the content output device 14A nor the device 14B is outputting the first content.

Returning to the description of step S7, if the output control unit 103 determines that either the content output device 14A or the device 14B is not outputting the second content (step S7: NO), it determines whether both the content output device 14A or the device 14B is outputting the second content (step S9).

If the output control unit 103 determines that neither the content output device 14A nor the device 14B is outputting the second content (step S9: NO), it ends this process.

A negative determination made in step S9 means that neither the content output device 14A nor the 14B is outputting content.

Contrarily, if the output control unit 103 determines that the content output devices 14A, 14B are both outputting the second content (step S9: YES), it executes a fourth processing (step S10).

A positive determination made in step S10 means that the content output devices 14A, 14B are both outputting the second content.

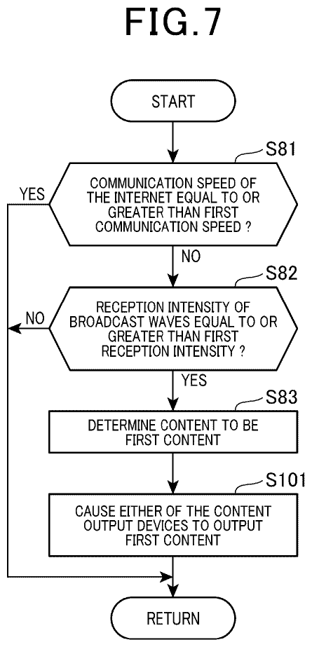

The first processing, the second processing, the third processing, and the fourth processing will be described respectively with reference to FIG. 4, FIG. 5, FIG. 6, and FIG. 7.

FIG. 4 is a flowchart showing the operation of the control ECU 19 in the first processing.

The output control unit 103 determines whether the reception intensity of the broadcast waves is equal to or greater than the first reception intensity (step S51).

If the output control unit 103 determines that the reception intensity of the broadcast waves is equal to or greater than the first reception intensity (step S51: YES), it ends the first processing. In other words, the output control unit 103 keeps the content output by either the content output device 14A or the device 14B being the first content.

Contrarily, if the output control unit 103 determines that the reception intensity of the broadcast waves is not equal to or greater than the first reception intensity (step S51: NO), it determines whether the communication speed of the Internet 2 is equal to or greater than the first communication speed (step S52).

If the output control unit 103 determines that the communication speed of the Internet 2 is not equal to or greater than the first communication speed (step S52: NO), it ends the first processing.

Contrarily, if the output control unit 103 determines that the communication speed of the Internet 2 is equal to or greater than the first communication speed (step S52: YES), it determines that the content to be output by the content output devices 14 is the second content (step S53).

Then, the output control unit 103 causes the content output device 14 outputting the first content to output the second content (step S54).

Step S54 corresponds to an “output step”.

For example, it is assumed that the content output device 14A is outputting a first content, and the content output device 14B is not outputting content. In this situation, if the reception intensity of the broadcast waves is less than the first reception intensity and the communication speed of the Internet 2 is equal to or greater than the first communication speed, the output control unit 103 causes the content output device 14A to output the second content.

Also, for example, it is assumed that the content output device 14B is outputting the first content, and the content output device 14A is not outputting content. In this situation, if the reception intensity of the broadcast waves is less than the first reception intensity and the communication speed of the Internet 2 is equal to or greater than the first communication speed, the output control unit 103 causes the content output device 14B to output the second content.

FIG. 5 is a flowchart showing the operation of the control ECU 19 in the second processing.

The output control unit 103 determines whether the reception intensity of the broadcast waves is equal to or greater than the first reception intensity (step S61).

If the output control unit 103 determines that the reception intensity of the broadcast waves is equal to or greater than the first reception intensity (step S61: YES), it determines whether the communication speed of the Internet 2 is equal to or higher than the first communication speed (step S62).

If the output control unit 103 determines that the communication speed of the Internet 2 is equal to or greater than the first communication speed (step S62: YES), it ends the second processing. In other words, the output control unit 103 keeps the content output by either of the content output devices 14A and 14B being the first content, and keeps the content output by either of the content output devices 14A and 14B being the second content.

If the output control unit 103 determines that the communication speed of the Internet 2 is not equal to or greater than the first communication speed (step S62: NO), it determines that the content to be output by the content output devices 14 to be the first content (step S63).

The output control unit 103 then causes the content output devices 14 to output the first content (step S64). As described above, in this embodiment, a plurality of content output devices 14 cannot simultaneously output the first content. Therefore, in step S64, the output control unit 103 causes the content output device 14 outputting the first content to continue outputting the first content, and stops the output of the second content by the other content output device 14.

Step S64 corresponds to an “output step”.

Step S64 will be described specifically.

For example, it is assumed that the content output device 14A is outputting the first content, and the content output device 14B is outputting the second content. In this situation, if the reception intensity of the broadcast waves is equal to or greater than the first reception intensity and the communication speed of the Internet 2 is less than the first communication speed, the output control unit 103 causes the content output device 14A to continue outputting the first content and stops the output of the second content by the content output device 14B.

Furthermore, for example, it is assumed that the content output device 14B is outputting the first content, and the content output device 14A is outputting the second content. In this situation, if the reception intensity of the broadcast waves is equal to or greater than the first reception intensity and the communication speed of the Internet 2 is less than the first communication speed, the output control unit 103 causes the content output device 14B to continue outputting the first content and stops the output of the second content by the content output device 14A.

Returning to the description of step S61, if the output control unit 103 determines that the reception intensity of the broadcast waves is not equal to or greater than the first reception intensity (step S61: NO), it determines whether the communication speed of the Internet 2 is equal to or greater than the first communication speed (step S65).

If the output control unit 103 determines that the communication speed of the Internet 2 is equal to or greater than the first communication speed (step S65: YES), it determines the content to be output by the content output devices 14 to be the second content (step S66).

The output control unit 103 then causes the content output devices 14 to output the second content (step S67). In this embodiment, a plurality of content output devices 14 can output the second content simultaneously. Therefore, in step S67, the output control unit 103 causes each of the content output devices 14A, 14B to output the second content.

Step S67 corresponds to an “output step”.

A specific example of step S67 will be described.

For example, it is assumed that the content output device 14A is outputting the first content, and the content output device 14B is outputting the second content. In this situation, if the reception intensity of the broadcast waves is less than the first reception intensity and the communication speed of the Internet 2 is equal to or greater than the first communication speed, the output control unit 103 causes the content output devices 14A, 14B to output the second content.

Returning to the description of step S65, if the output control unit 103 determines that the communication speed of the Internet 2 is not equal to or greater than the first communication speed (step S65: NO), it executes poorness processing (step S68).

The poorness processing is processing that is executed when the reception situation of the broadcast waves and the communication situation of the Internet 2 are poor.

A plurality of types of processing for poorness processing will be described below.

### <First Poorness Processing>

In the first poorness processing, a content output device 4 to output the content is selected based on the detection result of the gaze detection unit 104. In the first poorness processing, the selected content output device 14 outputs the content.

In the first poorness processing, the output control unit 103 acquires the detection result of the gaze detection unit 104, and selects the content output device 4 to output the content based on the acquired detection result of the gaze detection unit 104.

If the detection result of the gaze detection unit 104 includes the gaze direction of the driver P1 and the gaze direction of the driver P1 is toward the display 15A, the output control unit 103 selects the content output device 14A as the content output device 14 to output the content. Contrarily, if the detection result of the gaze detection unit 104 includes the gaze direction of the driver P1 and the gaze direction of the driver P1 is not toward the display 15A, the output control unit 103 does not select the content output device 14A as the content output device 14 to output the content.

If the detection result of the gaze detection unit 104 includes the gaze direction of the passenger P2 and the gaze direction of the passenger P2 is toward the display 15B, the output control unit 103 selects the content output device 14B as the content output device 14 to output the content. Contrarily, if the detection result of the gaze detection unit 104 includes the gaze direction of the passenger P2 and the gaze direction of the passenger P2 is not toward the display 15B, the output control unit 103 does not select the content output device 14B as the content output device 14 to output the content.

When the output control unit 103 selects a content output device 14, it causes the selected content output device 14 to output the content.

For example, it is assumed that the content output device 14A is outputting the first content, and the content output device 14B is outputting the second content. In this example, if the output control unit 103 has selected the content output device 14A in the first poorness processing, it causes the content output device 14A to continue outputting the first content and stops the output of the second content by the content output device 14B.

### <Second Poorness Processing>

In the second poorness processing, a content output device 4 to output the content is selected based on the detection result of the sitting situation detection unit 105. In the second poorness processing, the selected content output device 14 outputs the content.

In the second poorness processing, the output control unit 103 acquires the detection result of the sitting situation detection unit 105, and selects a content output device 4 to output the content based on the acquired detection result of the sitting situation detection unit 105.

If the detection result of the sitting situation detection unit 105 includes that an occupant P is sitting in the driver's seat 10A, the output control unit 103 selects the content output device 14A as the content output device 14 to output the content. Contrarily, if the detection result of the sitting situation detection unit 105 does not include that the occupant P is sitting in the driver's seat 10A, the output control unit 103 does not select the content output device 14A as the content output device 14 to output the content.

If the detection result of the sitting situation detection unit 105 includes that occupant P is sitting in the passenger seat 10B, the output control unit 103 selects the content output device 14B as the content output device 14 to output the content. Contrarily, if the detection result of the sitting situation detection unit 105 does not include that the occupant P is sitting in the passenger seat 10B, the output control unit 103 does not select the content output device 14B as the content output device 14 to output the content.

When the output control unit 103 selects a content output device 14, it causes the selected content output device 14 to output the content.

For example, it is assumed that the content output device 14A is outputting the first content, and the content output device 14B is outputting the second content. In this example, if the output control unit 103 has selected the content output device 14A in the second poorness processing, it causes the content output device 14A to continue outputting the first content and stops the output of the second content by the content output device 14B.

### <Third Poorness Processing>

In the third poorness processing, based on the determination result of the category determination unit 106, the content to be output by the content output devices 14 is determined to be the first content or the second content. Then, in the third poorness processing, the determined first content or second content is output by the content output devices 14.

The content categories are each given a priority order in output. For example, the category “traffic” has the highest priority. In addition, for example, the category “news” has the second highest priority after the category “traffic”. For example, the category “entertainment” has the lowest priority. The output priority order may be an order that can be changed by the occupant P, or an order that cannot be changed by the occupant P.

In the third poorness processing, the output control unit 103 acquires the determination result of the category determination unit 106, and determines the content to be output by the content output device 14 based on the acquired determination result of the category determination unit 106.

For example, it is assumed that the determination result of the category determination unit 106 includes that the category of the first content is “traffic”, and it is also assumed that the determination result of the category determination unit 106 includes that the category of the second content is “news”. It is also assumed that the priority in output is higher for the category “traffic” than for the category “news”. In this case, the output control unit 103 determines the content to be output by the content output devices 14 to be the first content.

For example, it is assumed that the determination result of the category determination unit 106 includes that the category of the first content is “entertainment”, and it is also assumed that the determination result of the category determination unit 106 includes that the category of the second content is “news”. It is also assumed that the priority in output is higher for the category “news” than for the category “entertainment”. In this case, the output control unit 103 determines the content to be output by the content output devices 14 to be the second content.

When the output control unit 103 determines the content to be output by the content output devices 14 to be the first content or the second content, it causes the content output devices 14 to output the determined first content or second content.

For example, it is assumed that the content output device 14A is outputting the first content, and the content output device 14B is outputting the second content. In this example, if the output control unit 103 has determined the content to be the first content in the third poorness processing, it causes the content output device 14A to continue outputting the first content and stops the output of the second content by the content output device 14B.

For example, it is assumed that the content output device 14A is outputting the first content, and the content output device 14B is outputting the second content. In this example, if the output control unit 103 has determined the content to be the second content in the third poorness processing, it stops the output of the first content by the content output device 14A and causes the content output device 14B to continue outputting the second content.

### <Fourth Poorness Processing>

In the fourth poorness processing, the content to be output by the content output devices 14 is determined to be the first content or the second content based on the calculation result of the processing load calculation unit 107. Then, in the fourth poorness processing, the determined first content or second content is output by the content output devices 14.

In the fourth poorness processing, the output control unit 103 acquires the calculation result of the processing load calculation unit 107, and determines the content to be output by the content output devices 14 based on the acquired calculation result of the processing load calculation unit 107.

If the processing load related to outputting the second content is greater than the processing load related to outputting the first content, the output control unit 103 determines that the content to be output by the content output devices 14 is the first content.

If the processing load related to outputting the first content is greater than the processing load related to outputting the second content, the output control unit 103 determines that the content to be output by the content output devices 14 to be the second content.

When the output control unit 103 determines the content to be output by the content output devices 14 to be the first content or the second content, it causes the content output devices 14 to output the determined first content or second content.

For example, it is assumed that the content output device 14A is outputting the first content, and the content output device 14B is outputting the second content. In this example, if the output control unit 103 determines the content to be output by the content output devices 14 to be the first content in the fourth poorness processing, it causes the content output device 14A to continue outputting the first content and stops the output of the second content by the content output device 14B.

For example, it is assumed that the content output device 14A is outputting the first content, and the content output device 14B is outputting the second content. In this example, if the output control unit 103 determines the content to be output by the content output devices 14 to be the second content in the fourth poorness processing, it stops the output of the first content by the content output device 14A and causes the content output device 14B to continue outputting the second content.

### <Fifth Poorness Processing>

In the fifth poorness processing, the content to be output by the content output devices 14 is determined to be the first content or the second content based on the calculation result of the communication charge calculation unit 108. Then, in the fifth poorness processing, the determined first content or second content is output by the content output devices 14.

In the fifth poorness processing, the output control unit 103 acquires the calculation result of the communication charge calculation unit 108, and determines the content to be output by the content output devices 14 based on the acquired calculation result of the communication charge calculation unit 108.

If the communication charge related to receiving the second content is equal to or greater than a predetermined value optionally set by the occupant P, the output control unit 103 determines that the content to be output by the content output devices 14 is the first content.

If the communication charge related to receiving the second content is not equal to or greater than the predetermined value optionally set by the occupant P, the output control unit 103 determines that the content to be output by the content output devices 14 to be the second content.

When the output control unit 103 determines the content to be output by the content output devices 14 to be the first content or the second content, it causes the content output devices 14 to output the determined first content or second content.

For example, it is assumed that the content output device 14A is outputting the first content, and the content output device 14B is outputting the second content. In this example, if the output control unit 103 determines the content to be output by the content output devices 14 to be the first content in the fifth poorness processing, it causes the content output device 14A to continue outputting the first content and stops the output of the second content by the content output device 14B.

For example, it is assumed that the content output device 14A is outputting the first content, and the content output device 14B is outputting the second content. In this example, if the output control unit 103 determines the content to be output by the content output devices 14 to be the second content in the fifth poorness processing, it stops the output of the first content by the content output device 14A and causes the content output device 14B to continue outputting the second content.

FIG. 6 is a flowchart showing the operation of the control ECU 19 in the third processing.

The output control unit 103 determines whether the communication speed of the Internet 2 is equal to or greater than the first communication speed (step S81).

If the output control unit 103 determines that the communication speed of the Internet 2 is equal to or greater than the first communication speed (step S81: YES), it ends the third processing.

Contrarily, if the output control unit 103 determines that the communication speed of the Internet 2 is not equal to or greater than the first communication speed (step S81: NO), it determines whether the reception intensity of the broadcast waves is equal to or greater than the first reception intensity (step S82).

If the output control unit 103 determines that the reception intensity of the broadcast waves is not equal to or greater than the first reception intensity (step S82: NO), it ends the third processing.

Contrarily, if the output control unit 103 determines that the reception intensity of the broadcast waves is equal to or greater than the first reception intensity (step S82: YES), it determines the content to be output by the content output devices 14 to be the first content (step S83).

Then, the output control unit 103 causes the content output device 14 outputting the second content to output the first content (step S83).

Step S83 corresponds to an “output step”.

For example, it is assumed that the content output device 14A is outputting second content, and the content output device 14B is not outputting any content. In this situation, if the reception intensity of the broadcast waves is equal to or greater than the first reception intensity and the communication speed of the Internet 2 is less than the first communication speed, the output control unit 103 causes the content output device 14A to output the first content.

For example, it is assumed that the content output device 14B is outputting the second content, and the content output device 14A is not outputting any content. In this situation, if the reception intensity of the broadcast waves is equal to or greater than the first reception intensity and the communication speed of the Internet 2 is less than the first communication speed, the output control unit 103 causes the content output device 14B to output the first content.

FIG. 7 is a flowchart showing the operation of the control ECU 19 in the fourth processing.

In FIG. 7, steps similar to those in FIG. 6 are given the same step numbers as in FIG. 6. In the description of FIG. 7, description of steps similar to those in FIG. 6 are omitted as appropriate.

When the output control unit 103 determines the content to be the first content (step S83), it causes either of the content output devices 14 to output the first content (step S101).

Step S101 corresponds to an “output step”.

For example, it is assumed that while the content output devices 14A, 14B are outputting the second content, the reception intensity of the broadcast waves is equal to or greater than the first reception intensity and the communication speed of the Internet 2 is less than the first communication speed. In this case, the output control unit 103 causes the content output device 14A to output the first content and stops the content output by the content output device 14B.

Furthermore, for example, it is assumed that while the content output devices 14A, 14B are outputting the second content, the reception intensity of the broadcast waves is equal to or greater than the first reception intensity and the communication speed of the Internet 2 is less than the first communication speed. In this case, the output control unit 103 causes the content output device 14B to output the first content and stops the content output by the content output device 14A.

### 4. Other Embodiments

The above-described embodiment shows only an aspect and can be modified and applied optionally.

In another embodiment, the communication charge calculation unit 108 may calculate the communication charge related to the reception of the first content. In the case of the other embodiment, the output control unit 103 compares the two types of communication charges calculated by the communication charge calculation unit 108 (the communication charge related to the reception of the first content and the communication charge related to the reception of the second content), and determines the content with the lower communication charge to be the content to be output by the content output devices 14.

In the fourth processing of the above-described embodiment, the output control unit 103 determines the content to be output by the content output devices 14 to be the first content. In fourth processing of another embodiment, the output control unit 103 may determine the content to be output by the content output devices 14 to be the second content. In this case, the output control unit 103 causes either of the content output devices 14A and 14B to output the first content. In this case, the content output device 14 that outputs the first content may be set based on factors such as the direction of occupant P's gaze or the sitting situation of occupant P. In addition, in fourth processing of another embodiment, the output control unit 103 may determine the content to be output by the content output devices 14 to be the first content and the second content. In this case, the output control unit 103 causes either of the content output devices 14A and 14B to output the first content, and causes either of the content output devices 14A and 14B to output the second content.

In another embodiment, the following configuration may be used in stopping content output by the content output device 14. In other words, the content output device 14 to be stopped inquires of the occupant P whether it is OK to stop content output. When the occupant P issues a stop command to the content output device 14A that has made the inquiry, the output control unit 103 stops the content output by the content output device 14 to be stopped.

In the above-described embodiment, the case has been exemplified in which the number of “content output devices” mounted on the “vehicle” is two. However, the number of “content output devices” mounted on the “vehicle” may be three or more. For example, the “vehicle” may be provided with a “content output device” including a display and a speaker at a position corresponding to each of the rear seats. Note that when the number of “content output devices” mounted on the “vehicle” is three or more, and the number of tuners 191 mounted on the “vehicle” is one, the plurality of “content output devices” cannot output the first content simultaneously.

In the above-described embodiment, the number of tuners 191 mounted on the “vehicle” is one. However, in other embodiments, the number of tuners 191 mounted on the “vehicle” may be more than one. In the other embodiment, a number of tuners 191 mounted on the “vehicle” may be the same as that of “content output devices” mounted on the “vehicle”, or a number of tuners 191 mounted on the “vehicle” may be smaller than that of “content output devices” mounted on the “vehicle”. In the other embodiment, there are as many “content output devices” as there are tuners 191 and the “content output devices” can simultaneously output the first content.

In another embodiment, the “content output device” may be only a display or only a speaker.

In another embodiment, the first poorness processing is not necessarily performed. In the case of the other embodiment, the vehicle 1 does not need to have the cameras 18A and 18B. In the case of the other embodiment, the processor 100 does not need to function as the gaze detection unit 104.

In another embodiment, the second poorness processing is not necessarily performed. In the case of the other embodiment, the vehicle 1 does not need to be equipped with a seat sensor 13. In the case of the other embodiment, the processor 100 does not need to function as the sitting situation detection unit 105.

In another embodiment, the third poorness processing is not necessarily performed. In the case of the other embodiment, the processor 100 does not need to function as the category determination unit 106. In the case of the other embodiment, the content-related information does not need to include category information.

In another embodiment, the fourth poorness processing is not necessarily performed. In the case of the other embodiment, the processor 100 may not function as the processing load calculation unit 107.

In other embodiments, the fifth poorness processing is not necessarily performed. In the case of the other embodiment, the processor 100 does not need to function as the communication charge calculation unit 108.

The processor 100 may be composed of a plurality of processors or may be composed of a single processor. The processor 100 may be hardware programmed to implement the above-described functional units. In this case, processor 100 is composed, for example, of an ASIC (Application Specific Integrated Circuit) or FPGA (Field Programmable Gate Array).

The configuration of the content output system 12 shown in FIG. 2 is an example, and the specific implementation form is not particularly limited. In other words, it is not necessarily necessary to implement hardware corresponding to each part individually, and a configuration is of course possible in which one processor executing a program implements the function of each part. Furthermore, some of the functions implemented by software in the above-described embodiment may be implemented by hardware, or some of the functions implemented by hardware may be implemented by software.

In addition, the step units of the operations shown in FIGS. 3 to 7 are divided according to the main processing contents, and the present invention is not limited by the way in which the processing units are divided or the names thereof. The processing may be divided into even more step units depending on the processing contents. Furthermore, one step unit may be divided so as to include even more processes. The order of the steps may be changed as appropriate within the scope of the spirit of the present invention.

When the above-described method for controlling content output system 12 is implemented using processor 100, it is also possible to compose the program executed by processor 100 in a form of a recording medium or a transmission medium for transmitting this program. In other words, the control program 111 can also be implemented in such a manner that the control program 111 is recorded on a portable information recording medium. Examples of the information recording media include a magnetic recording medium such as a hard disk, an optical recording medium such as a CD, and a semiconductor storage device such as a USB (Universal Serial Bus) memory and an SSD (Solid State Drive), but other recording media can also be used.

### 5. Configuration Supported by the Above Embodiment

The above embodiment supports the following configuration.

### (Configuration 1)

A content output system, including: a plurality of content output devices mounted on a vehicle; and a control unit that controls the content output devices, wherein the control unit includes: a first content acquisition unit that acquires content by receiving broadcast waves; a second content acquisition unit that acquires content by receiving data from an Internet; and an output control unit that causes the content output devices to output content, and the output control unit determines content to be output by the content output devices to be first content or second content based on a reception situation of the broadcast waves and a communication situation of the Internet, the first content being acquired by the first content acquisition unit, the second content being acquired by the second content acquisition unit.

The content output system of configuration 1 makes it possible to automatically change the content output by the content output devices in response to the reception situation of the broadcast waves and the communication situation of the Internet, without the occupant performing any special operation such as switching. This therefore makes it possible to improve the convenience of the occupant relating to content output in a vehicle equipped with a plurality of content output devices.

### (Configuration 2)

The content output system according to configuration 1, wherein when a reception intensity of the broadcast waves is less than a first reception intensity and a communication speed of the Internet is equal to or greater than a first communication speed, the output control unit determines content to be output by the content output devices to be the second content.

The content output system of configuration 2 makes it possible to automatically change the content output by the content output devices to content that can be output well, without the occupant performing any special operation. This therefore makes it possible to further improve the convenience of the occupant relating to content output in a vehicle equipped with a plurality of content output devices.

### (Configuration 3)

The content output system according to configuration 1 or 2, wherein when a reception intensity of the broadcast waves is equal to or greater than a first reception intensity and a communication speed of the Internet is less than a first communication speed, the output control unit determines content to be output by the content output devices to be the first content.

The content output system of configuration 3 provides the same effect as the content output system of configuration 2.

### (Configuration 4)

The content output system according to configuration 2 or 3, wherein the control unit includes a gaze detection unit that detects a direction of a gaze of each of occupants of the vehicle, and when the plurality of content output devices output the first content and the second content, a reception intensity of the broadcast waves is less than the first reception intensity, and a communication speed of the Internet is less than the first communication speed, the output control unit selects at least one of the plurality of content output devices to output content based on a detection result of the gaze detection unit, and causes the selected content output device to output content.

The content output system of configuration 4 causes the content output device, which has the content that is highly likely to be used, to output the content when the first content and the second content cannot be output well. This therefore makes it possible to reduce the number of content output devices that output content, reducing the processing load related to content output, and preventing the output content from being even worse. In addition, since the content is output by the content output device, which has the content that is highly likely to be used, it is possible to prevent the convenience of the occupant relating to content output from being impaired.

### (Configuration 5)

The content output system according to configuration 2 or 3, wherein the control unit includes a sitting situation detection unit that detects a sitting situation of an occupant of the vehicle, and when the plurality of content output devices output the first content and the second content, a reception intensity of the broadcast waves is less than the first reception intensity, and a communication speed of the Internet is less than the first communication speed, the output control unit selects at least one of the plurality of content output devices to output content based on a detection result of the sitting situation detection unit and causes the selected content output device to output content.

The content output system of configuration 5 provides the same effect as the content output system of configuration 4.

### (Configuration 6)

The content output system according to configuration 2 or 3, wherein the control unit includes a category determination unit that determines a category of the first content and a category of the second content, and when the plurality of content output devices output the first content and the second content, a reception intensity of the broadcast waves is less than the first reception intensity, and a communication speed of the Internet is less than the first communication speed, the output control unit determines content to be output by the content output devices to be the first content or the second content based on a determination result of the category determination unit.

The content output system of configuration 6 sets the content output by the content output devices to the first content or the second content based on the category of content when the first content and the second content cannot be output well. This therefore makes it possible to set the content to be output in the vehicle to the first content or the second content, reducing the processing load related to the content output compared to a case in which both contents are output. This makes it possible to prevent the output content from being even worse. Furthermore, this makes it possible to set the content output by the content output device to the first content or the second content based on the category of content, outputting the category of content that the occupant desires or the category of content that the occupant should view, and preventing the convenience of the occupant relating to content output from being impaired.

### (Configuration 7)

The content output system according to configuration 2 or 3, wherein the control unit includes a processing load calculation unit that calculates a processing load related to output of the first content and a processing load related to output of the second content, and when the plurality of content output devices output the first content and the second content, a reception intensity of the broadcast waves is less than the first reception intensity, and a communication speed of the Internet is less than the first communication speed, the output control unit determines content to be output by the content output devices to be the first content or the second content based on a calculation result of the processing load calculation unit.

The content output system of configuration 7 sets the content to be output by the content output devices to the first content or the second content based on the processing load related to the content output when the first content and the second content cannot be output well. This therefore makes it possible to output content with a low processing load, reducing the processing load related to the content output. This makes it possible to prevent the output content from being even worse. Furthermore, this makes it possible to automatically output content with a low processing load without the occupant performing any special operation, improving the convenience of the occupant relating to content output.

### (Configuration 8)

The content output system according to configuration 2 or 3, wherein the control unit includes a communication charge calculation unit that calculates a communication charge for the Internet, and when the plurality of content output devices output the first content and the second content, a reception intensity of the broadcast waves is less than the first reception intensity, and a communication speed of the Internet is less than the first communication speed, the output control unit determines content to be output by the content output devices to be the first content or the second content based on a calculation result of the communication charge calculation unit.

The content output system of configuration 8 sets the content output by the content output devices to the first content or the second content based on the calculated communication charge when the first content and the second content cannot be output well. This therefore makes it possible to set the content output in the vehicle to the first content or the second content, reducing the processing load related to the content output. This makes it possible to prevent the output content from being even worse. Furthermore, this makes it possible to automatically output content with a low communication charge without the occupant performing any special operation, improving the convenience of the occupant relating to content output.

### (Configuration 9)

The content output system according to any one of configurations 2 to 8, wherein when a reception intensity of the broadcast waves is less than a second reception intensity that is less than the first reception intensity and a communication speed of the Internet is less than a second communication speed that is less than the first communication speed, the output control unit does not cause the content output devices to output content.

The content output system of configuration 9 makes it possible to prevent the content output devices from outputting the content when the content is highly likely to fail in appropriate output, preventing the occupant from feeling annoyed with the content output.

### (Configuration 10)

A method for controlling a content output system including a plurality of content output devices mounted on a vehicle, the method including an output step for causing the content output devices to output content, wherein the output step determines content to be output by the content output devices to be first content obtained by reception of the broadcast waves or second content obtained by reception of data from an Internet, based on a reception situation of broadcast waves and a communication situation of the Internet.

The method for controlling the content output system of configuration 10 provides the same effect as the content output system of configuration 1.

### REFERENCE SIGNS LIST

1 . . . vehicle, 2 . . . Internet, 3 . . . mobile terminal, 4 . . . content output device, 10A . . . driver's seat, 10B . . . passenger seat, 10C . . . rear right seat, 10D . . . rear left seat, 11A . . . right front door, 11B . . . left front door, 11C . . . right rear door, 11D . . . left rear door, 11E . . . tailgate, 12 . . . content output system, 13, 13A to 13D . . . seat sensor, 14, 14A, 14B . . . content output device, 15A, 15B . . . display, 16A, 16B . . . speaker, 17 . . . dashboard, 18A, 18B . . . camera, 19 . . . control ECU (control unit), 20 . . . TCU, 100 . . . processor, 101 . . . first content acquisition unit, 102 . . . second content acquisition unit, 103 . . . output control unit, 104 . . . gaze detection unit, 105 . . . sitting situation detection unit, 106 . . . category determination unit, 107 . . . processing load calculation unit, 108 . . . communication charge calculation unit, 110 . . . memory, 111 . . . control program, 190 . . . control device, 191 . . . tuner, 192 . . . communication unit, P . . . occupant, P1 . . . driver, P2 . . . passenger, S54, S64, S67, S84, S101 . . . step (output step).

What is claimed is:

1. A content output system, comprising:
a plurality of content output devices mounted on a vehicle; and
a control unit that controls the content output devices, wherein
the control unit includes:
a first content acquisition unit that acquires content by receiving broadcast waves;
a second content acquisition unit that acquires content by receiving data from an Internet; and
an output control unit that causes the content output devices to output content, and
the output control unit
determines content to be output by the content output devices to be first content or second content based on a reception situation of the broadcast waves and a communication situation of the Internet, the first content being acquired by the first content acquisition unit, the second content being acquired by the second content acquisition unit.

2. The content output system according to claim 1, wherein
when a reception intensity of the broadcast waves is less than a first reception intensity and a communication speed of the Internet is equal to or greater than a first communication speed,
the output control unit
determines content to be output by the content output devices to be the second content.

3. The content output system according to claim 1, wherein
when a reception intensity of the broadcast waves is equal to or greater than a first reception intensity and a communication speed of the Internet is less than a first communication speed,
the output control unit
determines content to be output by the content output devices to be the first content.

4. The content output system according to claim 2, wherein
the control unit includes a gaze detection unit that detects a direction of a gaze of each of occupants of the vehicle, and
when the plurality of content output devices output the first content and the second content, a reception intensity of the broadcast waves is less than the first reception intensity, and a communication speed of the Internet is less than the first communication speed,
the output control unit
selects at least one of the plurality of content output devices to output content based on a detection result of the gaze detection unit, and causes the selected content output device to output content.

5. The content output system according to claim 2, wherein
the control unit includes a sitting situation detection unit that detects a sitting situation of an occupant of the vehicle, and
when the plurality of content output devices output the first content and the second content, a reception intensity of the broadcast waves is less than the first reception intensity, and a communication speed of the Internet is less than the first communication speed,
the output control unit
selects at least one of the plurality of content output devices to output content based on a detection result of the sitting situation detection unit and causes the selected content output device to output content.

6. The content output system according to claim 2, wherein
the control unit includes a category determination unit that determines a category of the first content and a category of the second content, and
when the plurality of content output devices output the first content and the second content, a reception intensity of the broadcast waves is less than the first reception intensity, and a communication speed of the Internet is less than the first communication speed,
the output control unit
determines content to be output by the content output devices to be the first content or the second content based on a determination result of the category determination unit.

7. The content output system according to claim 2, wherein
the control unit includes a processing load calculation unit that calculates a processing load related to output of the first content and a processing load related to output of the second content, and
when the plurality of content output devices output the first content and the second content, a reception intensity of the broadcast waves is less than the first reception intensity, and a communication speed of the Internet is less than the first communication speed,
the output control unit
determines content to be output by the content output devices to be the first content or the second content based on a calculation result of the processing load calculation unit.

8. The content output system according to claim 2, wherein
the control unit includes a communication charge calculation unit that calculates a communication charge for the Internet, and
when the plurality of content output devices output the first content and the second content, a reception intensity of the broadcast waves is less than the first reception intensity, and a communication speed of the Internet is less than the first communication speed,
the output control unit
determines content to be output by the content output devices to be the first content or the second content based on a calculation result of the communication charge calculation unit.

9. The content output system according to claim 2, wherein
when a reception intensity of the broadcast waves is less than a second reception intensity that is less than the first reception intensity and a communication speed of the Internet is less than a second communication speed that is less than the first communication speed,
the output control unit
does not cause the content output devices to output content.

10. A method for controlling a content output system including a plurality of content output devices mounted on a vehicle, the method comprising
an output step for causing the content output devices to output content, wherein
the output step
determines content to be output by the content output devices to be first content obtained by reception of the broadcast waves or second content obtained by reception of data from an Internet, based on a reception situation of broadcast waves and a communication situation of the Internet.
